(19) United States
(12) Patent Application Publication
(10) Pub. No.: US 2003/0229796 A1
(43) Pub. Date: Dec. 11, 2003

(54) System guide device based on flash memory and the implement of guide method

(76) Inventor: Hsuan-Ming Shih, Taipei (TW)

Correspondence Address: TAI GUEN ENTERPRISE CO., LTD., Chung-Ho, P. O. Box No.6-57, Taipei, 235, TW

(21) Appl. No.: 10/163,516

(22) Filed: Jun. 7, 2002

(51) Int. Cl. G06F 11/30

(52) U.S. Cl. 713/193

(57) ABSTRACT

A system guide device based on flash memory and the implement of guide method is disclosed. The device comprises an external housing and a control circuit within the housing. The control circuit includes USB interface, flash memory, CPU, storage device, wherein the CPU completes address selection and module conversion, and the ports thereof are connected to USB flash memory, and storage device. The CPU port is also connected to IR module or emitting frequency notification module with sensing antenna.

### BACKGROUND OF THE INVENTION

(a) FIELD OF THE INVENTION

The present invention relates to a system guide device based on flash memory and the implement of guide method, wherein the present invention provides large storage capacity and storage reliability and has a smaller volume facilitating portability.

(b) Description of the Prior Art

Conventional mobile storage device is not conveniently moved as a result of large volume, for instance, the externally mounted hard disc, externally crave and record device, ZIP, MO, etc. These devices can provide larger storage capacity but they are insufficient mobility. If these devices are used as portable memory, for instance soft disc, a large space within the driving device will be taken up, and the energy exhaustion, noise are high. As the operation of the soft driver is slow, the storage space is small and the data storage is not reliable. As the soft disc is a portable product, physical damages are easily found. Therefore, frequent maintenance is a troublesome and the efficiency of the device is low. In reality the existing memory is not practical and therefore it is an object of the present invention to provide a system guide device which overcomes the above drawbacks.

### SUMMARY OF THE INVENTION

It is an object of the present invention to provide a system guide device based on flash memory and the implement of guide method, wherein a guide plate for PC is used to complete system guide imitation.

Yet another object of the present invention is to provide a system guide device based on flash memory and the implement of guide method, wherein the device has a large storage capacity, high reliability of storage, volume convenient to portable, allowing to gather to form emitting frequency identification device or function as wireless receiving element and is used as an external communication interface for PC.

A further object of the present invention is to provide a system guide device based on flash memory and the implement of guide method, wherein confidential information can further be kept secret and is useful to read and write data of the manager.

Still an object of the present invention is to provide a system guide device based on flash memory and the implement of guide method, wherein the management process is done via storage region of the flash memory as an electronic lock and a safety precaution to the application of computer.

Other objects and advantages of the present invention will become more apparent from the following description taken in conjunction with the accompanying drawing.

### BRIEF DESCRIPTION OF THE DRAWINGS

FIG. 1 shows a perspective view of a system guide device in accordance with the present invention.

FIG. 2. is a flowchart of a system guide device in accordance with the present invention.

FIG. 3 shows another preferred embodiment of a system guide device in accordance with the present invention.

FIG. 4 is a flowchart showing the connection of flash memory, buffer, CPU and junctions of the system guide device in accordance with the present invention.

FIG. 5 is a circuit diagram of a system guide device in accordance with the present invention.

FIG. 6 is a flowchart showing the method of implementing the guide method of the system guide device in accordance with the present invention.

FIG. 7 is a flowchart showing the method of data protected confidentially in accordance with the system guide device in accordance with the present invention.

FIG. 8 shows the division of externally mounted hardware into a Public Region and a Protection Region in accordance with the system guide device in accordance with the present invention.

FIG. 9 shows the division of externally mounted hardware into a Public Region, a Protection Region, and a Coded Region in accordance with the present invention.

### DETAILED DESCRIPTION OF THE PRESENT INVENTION

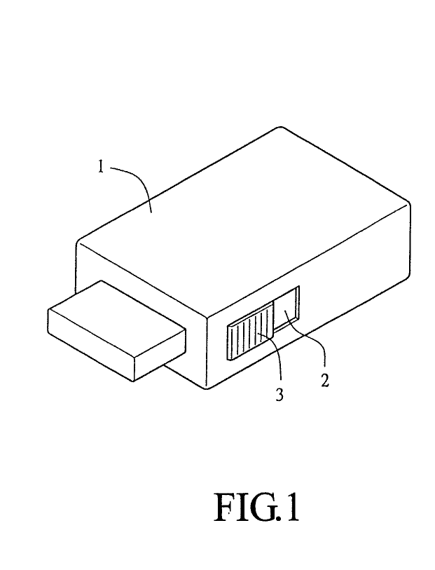

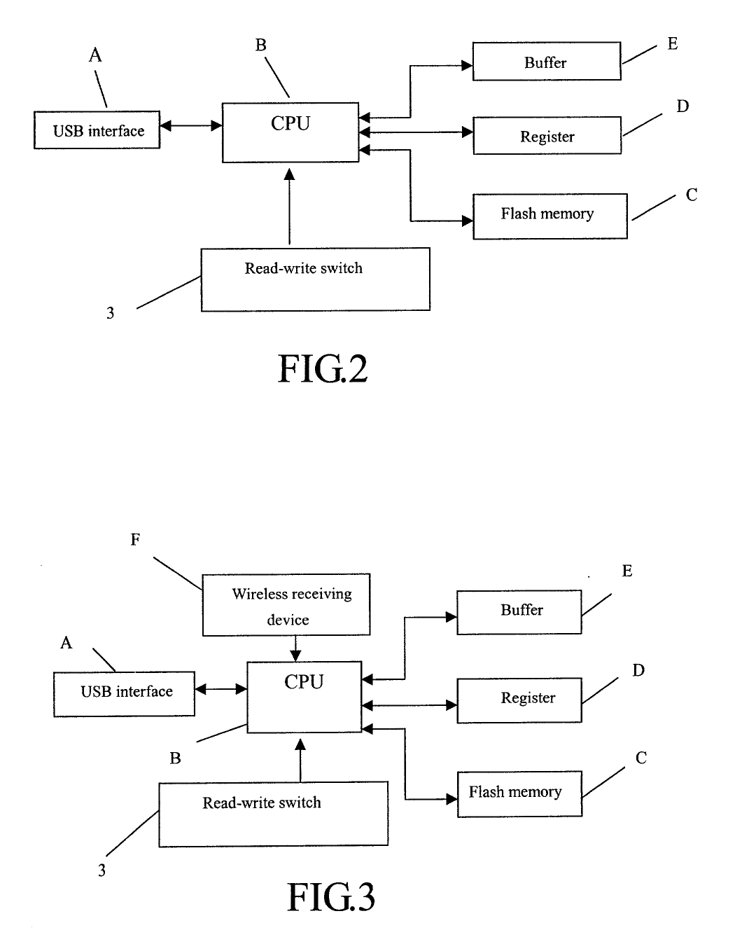

Referring to FIGS. 1, 2 and 3, there is shown a system guide device based on flash memory and the implement of guide method, and the device includes an external housing 1 and a control circuit within the housing 1. The control circuit includes USB interface A, CPU B, flash memory C, storage device D and buffer E, wherein CPU B completes address communication and modular conversion and the ports of the CPU B is connected to USB A, the flash memory C and the storage device D.

The external side of the housing 1 is provided with a window 2 having a Read Write control switch 3 and one end of the control switch 3 is connected to the Read Write control port line of the CPU B port, and the other end is connected to ground. The control section of the control switch 3 is located at the external section of the housing 1.

The switch 3 is a sliding switch for a guiding slot and moves along the window 2, or a press switch or a switch which can be triggered to the left and right. The CPU B is connected to memory with electronic lock secret code or guiding program and wireless receiving device F.

As for moving storage, the flash memory is used as a storage medium and the capacity is determined by the size of the flash memory. User can moves large capacity data or exchange data and the flash memories can be connected in series to increase the capacity of the flash memories.

The USB interface A is in communication with PC and it can be plugged in directly for utilization and can be used for movement of storage.

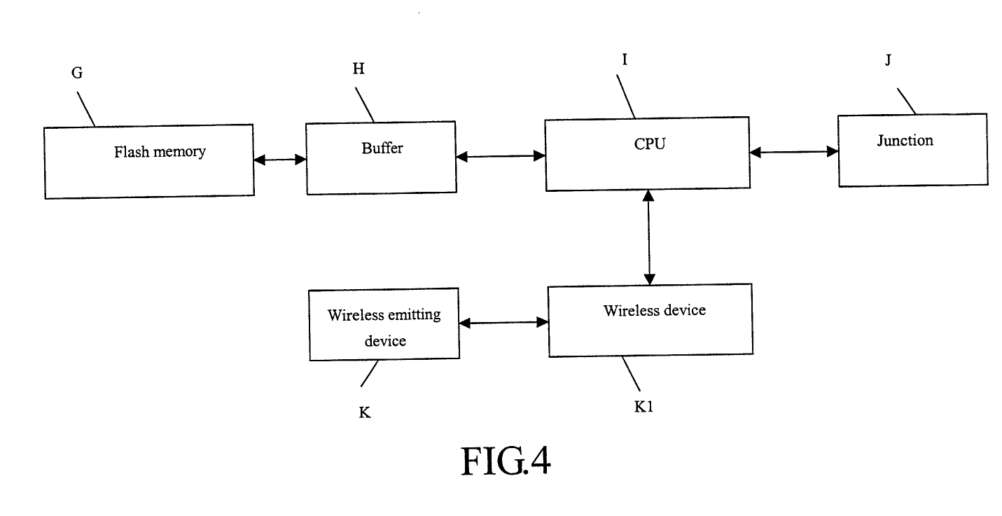

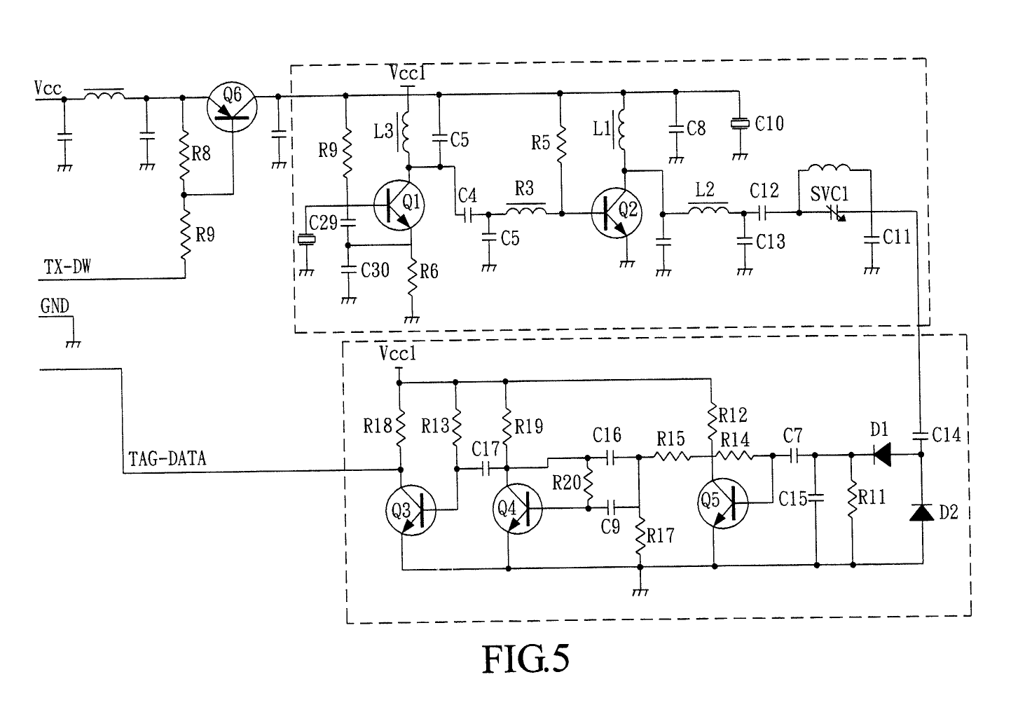

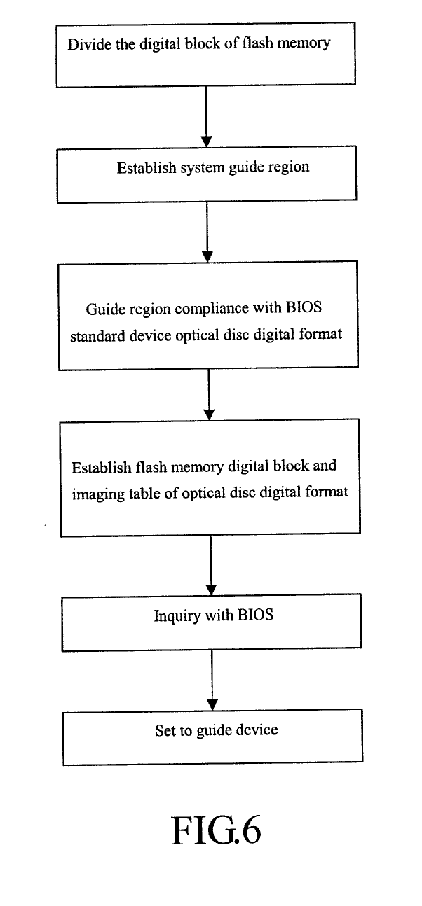

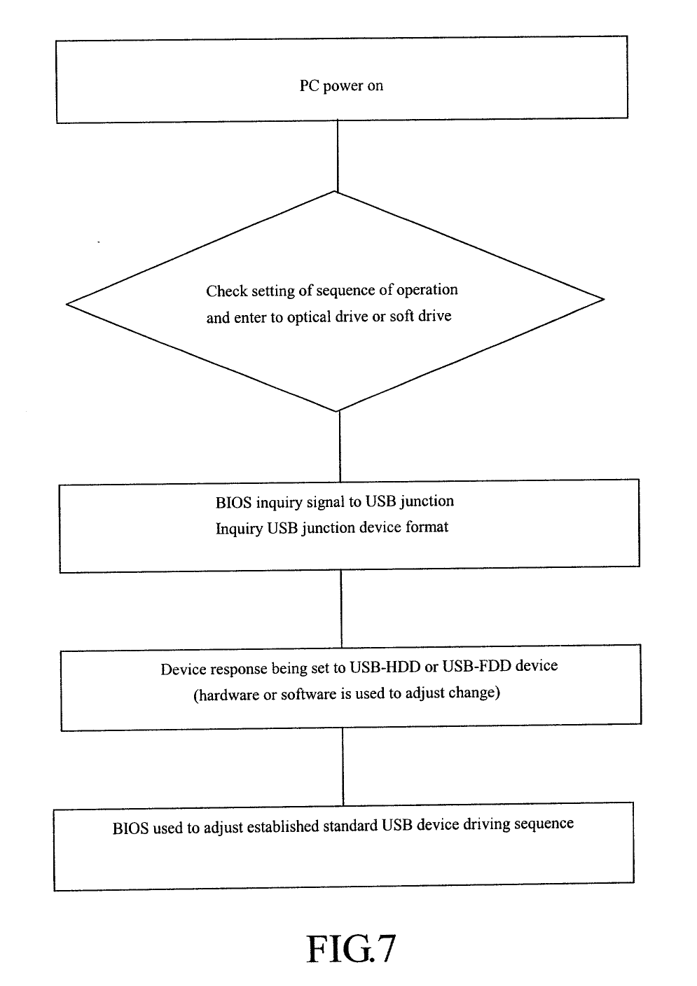

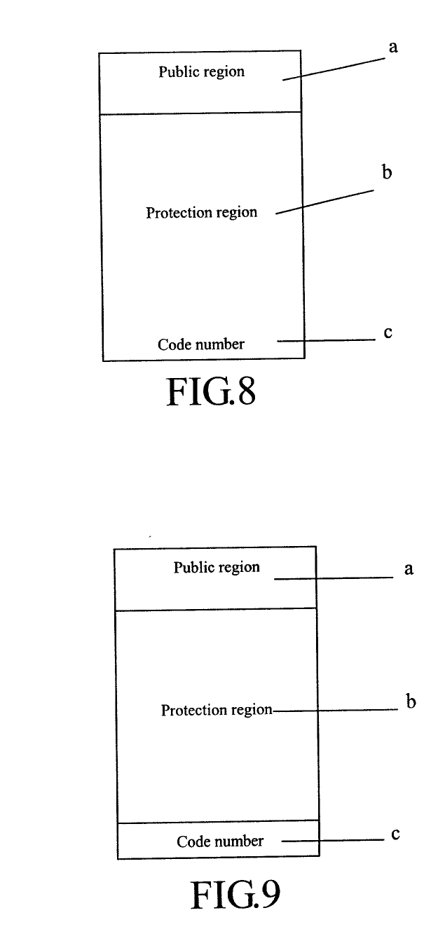

Referring to FIG. 4, the device comprises flash memory G, a buffer H, CPU I, interconnected junction J and wireless emitting device K and wireless device K1 are used to directly control the CPU I.

The structure of the circuit is used for data storage and data transmission is done through DP, DN lead leg and the USB junction of the main board. The data of the hard disk is inter-transmitted with that of the flash memory and the data is portable.

The USB input voltage is DC 5V and the working voltage is 3.3V. Thus, the circuit employs circuit covering 5V DC to 3.3V.

U1 is USB IC, via DATA+, DATA− lead leg connected to USB junction, 15 address line, 2 sets of data line, 32 I/O junction, RD, WR lead leg to proceed to data read and write operation

U3 is a flash memory, the inter-transmitted data between the hard disc can be stored therein. If power is cut off, the data still remains.

U4 is a buffer, having 15 address lines A0-A15, 1 set of data line 101/108 and is used for temporary storage of data.

U6 is a memory to place code, through the connection between the main IC and SDA, SCL lead leg, U6 is used to read and access the description of device so as to identify the type of device. When the device is inserted into the USB junction, via internet DN, DP will transmit data to the main chip U1, 1C for the treatment. Data is read from serial EEPROM U6, and commands are reset simultaneously, the device is reset. At this instance, the device is at normal working status. Read Write switch SW1 is connected to WDA2 of CPU and the control end is connected to high frequency so as to permit “Read” and “Write”, or via the resistance R3 connected to ground, only Read is possible.

When the system is reset, data transmission is initiated and the host computer will provide a command to open the disc-selection and initiate the RD or WR control signals, data from the hard disk, via address line to select its address, via data line to transmit data and store to U4 SRAM or U3 flash memory.

CMOS SRAM is used as a buffer and when power is cut off, data will be lost but the data within the flash memory will not. Thus, the final data will be placed in the U3 flash memory MEMORY for storage allowing portability when desired.

The USB electronic disc is provided with a wireless antenna. The mounting of the antenna to the USB electronic disc increases the practicability of the USB electronic disc and reduces problems due to insufficient USB junction.

The wireless device can be IR device, RF device and RFID device, and external data passes through TAG DATA wireless path, for instance sensing signal of the antenna, or IR receiving element, to the receiving unit. When the data entering the connection unit, it will transfer to the delivery unit and via the TX-PW lead leg of the delivery unit, the data is transmitted to CPU as shown in FIG. 4. CPU receives data via SDA, SCL lead leg and transmits data to PC via USB junction.

Among the wireless devices, RF wireless transmission device and IR indefinite transmission device are the major devices. Based on the wireless device to determine transmission mode and transmission frequency. Among RF wireless device, all product having receiving end gathered at the USB electronic disc can be employed, for instance, RFID receiving end.

Within the hardware of the controller, data from different sources are distributed to output ports, transmitting to PC. The receiving device of the wireless device receives signals from the emitted signal by the wireless device. These signals, via controller, are converted to USB/PS-2/1394 interface format and transmitted to computer.

Read: NAND-type of data is first transmitted to Buffer (SRAM). These data is converted, via controller, to USB, PS/2, 1394 etc, interface format to the computer.

Write: Data which to be transmitted by computer to the flash memory is first transmitted to the buffer. When the buffer is full, the data is then transmitted to the flash memory.

In the present invention, emitting end function TAG is added. The TAG is provided by other door security system which is added to the device, or the PC is added with a RFID receiving end section, so that the present invention is used to identify the identity of PC end.

TAG is classified into active type and passive type. The passive type is used to dentify fixed position identity. The active type is used to remotely identify product. Due to the need of a user to press a button and to actively print the identifying action, it can be used to proceed non-instinctive identification action so as to achieve identify identification. After the USB flash disc is added with RFID TAG, the meaning of mobile office and mobile storage is greatly extended. Mobile storage device can be employed on PC and in everyday life, USB flash memory Disk is used as the electronic identify certification center, such as door security system, car alarm system, etc.

In accordance with the present invention, the implementation of system guide method are as follows:

(a) dividing the data block of a flash memory into a system guide region and a data storage region; (b) matching the system guide region with magnetic guide data format of the CIOS standard device; (c) establishing data block radiated schedule matching the magnetic data format; (d) proceeding inquiry via data exchange interface and BIOS to complete compliance assisted storage formatted determination process; and (e) and setting the flash memory as guide device.

Referring to FIGS. 9, 10, the externally mounted hardware divides the storage device into several regions, each region is operated as

(1) Public Region (a): The public region provides user an open read and write region. The user does not have the right to write or read the disc symbols of the protected region.

(2) Protected Region (b): It operation is similar to that of hard disk. One executable document can be executed within the Public Region and after a correct code is input, the data can be read and access.

(3) Coded Region (c): User has to provide the correct code to execute document in this coded Region in order to read and access the storage data. If the code is correct, the Protected Region will provide a disc symbol to the user. Other wise, the user can only use the Public Region. If the code number is incorrect, the coded Region will provide correction so that the code number of user will be kept confidential.

The method of computer lock is as follows:

After a long period of plug-in the device at the USB junction, via the editing of the hardware or the loading of a driving program, the device can be added with computer defense locking function. Before the user plugs in the device, PC can not be operated or initiated or partial of the program cannot be executed. This device can also be used to record computer utilization records, including all the action after logged in.

There are two types of implementation method, i.e., with BIOS: the device being provided with two sets of code number and these two sets of numbers can be used simultaneously, or one is selected. For fixed code number: for PID, and VID device, after the BIOS passed the standard device at POST to read and access PID and VID of the present invention only when it complies with that in the BIOS, PC can only be initiated normally.

Variable code number: user can save a favorable number in the present device and the storage medium is EEPROM or the security area or password area of the flash memory, after the PC is turned on, BIOS will automatically require the user to input the code number upon certification and confirmation, the PC is operated normally. User can change the code number by means of BIOS interface or internal application program.

If the user has already loaded the driving program, the system will automatic open a code number window for the user to enter the code number and to compare with that in the USB electronic disc. If the code number is not similar, and the user continues to use the computer, the computer will shut off by cutting off all the communication ports, ex-serial port, USB port, PS/2 port, parallel port.

If the preset device is to be used as PC guide disk, the device is inserted into the USB slot. This will provide larger storage capacity and rapid in read and write.

Alone Usage of the preset device: when the device does not combine with BIOS, a driving program has to be installed under operating system to implement computer locking. Computer code number is stored at the coded region or protected region. After the operating system is loaded, first time user enters the protected region to install the driving program via the data protection function. After the driving program is installed, computer code number has to be key in to allow application right of the computer. PC will check whether USB electronic disc has been inserted and whether the input code number is similar to that of the computer code number with the USB electronic disk. If not, the computer will prohibit the user's application by: cut off all the communication port function, ex serial port, USB port, PS/2 port, parallel port.

The advantages of the present invention are as follows:

1. The present device is thin, light and small in size as that of a pen and provides large storage space and the stored data is safe and is not easily physically destroyed.

2. The present device can be used conveniently without opening the housing of the computer. Only a USB device interface is needed without isolated driver and disc, as a result no support system problem will occur.

3. The present device has great mobility and can be operated without operating system to achieve the object.

4. The storage data of the present device is reliable as the flash memory will not be easily physically damaged. User can move the data conveniently.

5. The present device provides confidential protection on the electronic disc.

6. The present device allows PC electronic lock.

7. The present device is incorporated with RFID transmitting gate (TAG) and therefore it provides a safe guard to the computer.

8. Company TAG can be incorporated into the present device to replace the existing identification card.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A system guide device based on flash memory having an external housing and a control circuit therein, characterized in that the control circuit includes computer communication interface, flash memory, CPU, storage device, wherein the CPU completes address selection and communication and data coordination and the port of the CPU connects the interface, flash memory and storage device.

2. The system guide device as set forth in claim 1, wherein the communication interface is USB interface.

3. The system guide device as set forth in claim 1, wherein the control circuit includes read write control circuit, one end of the read write control circuit being connected to a CPU port, and the other end being connected to high electrical frequency or ground.

4. The system guide device as set forth in claim 3, wherein the read write control switch control section is located at the exterior of the housing.

5. The system guide device as set forth in claim 1, wherein the CPU is connected to a storage device having electronic locking code number or guide program.

6. The system guide device as set forth in claim 1, wherein the storage device is a partial storage region of flash memory or an independent memory.

7. The system guide device as set forth in claim 1, wherein the CPU port is connected to output of a wireless receiving apparatus being mounted on the body of the guide device.

8. The system guide device as set forth in claim 6, wherein the wireless receiving device is a IR module or an emitting frequency identification module having sensing antenna.

9. A method of implementing a guide device based on flash memory comprising the steps of: dividing the data block of a flash memory into a system guide region and a data storage region; matching the system guide region with magnetic guide data format of the CIOS standard device; establishing data block radiated schedule matching the magnetic data format; proceeding inquiry via data exchange interface and BIOS to complete compliance assisted storage formatted determination process; and setting the flash memory as guide device.

10. The method of implementing a guide device based on flash memory system as set forth in claim 9, wherein the guide data format is hard disk or soft disc guide data format.

11. The method of implementing a guide device based on flash memory system as set forth in claim 9, wherein the data block of the flash memory is matched with partial data block.

12. The method of implementing a guide device based on flash memory system as set forth in claim 9, wherein the data exchange interface is USB interface.

13. The method of implementing a guide device based on flash memory system as set forth in claim 9, wherein the flash memory device is provided with hard disk and soft disc guide data format conversion switch.

14. The method of implementing a guide device based on flash memory system as set forth in claim 13, wherein the conversion switches are respectively connected to hard disc and soft disc guide data format region conversion circuit or initiating coordination commands.

15. The method of implementing a guide device based on flash memory system as set forth in claim 9, wherein the memory data storage is divided into public data region and protection region, the permitted code number of data read and write is located in the protection region, or the data region of the memory is divided into code number storage region and the code number is located within the code number storage region; the public region is provided with executed document to check the code number, and the execute the document and the correct code is input and the read and access the code number region or the code storage region of the protection region so as to compare, if the code number is similar, the protection region is open to the user and provides a disc symbol, if not, user can only use the public region and indicates that the code number is incorrect.

16. The method of implementing a guide device based on flash memory system as set forth in claim 15 wherein the determination is done between the PC and the flash memory to obtain right to utilize the PC.

17. The method of implementing a guide device based on flash memory system as set forth in claim 16, wherein the permission determination is done by flash memory and the BIOS of the PC, the storage region contains two sets of code numbers, a fixed code and a variable code number, via standard device, PID and VID are read and access, only when they comply with the database of the BIOS, PC will then proceed to normal operation, and after PC is switched on, BIOS automatically requires the user to key in the code number and normal operation is available when the code number is correct.

18. The method of implementing a guide device based on flash memory system as set forth in claim 16, wherein first time user enters the protected region to install the driving program via the data protection function, and after the driving program is installed, computer code number has to be key in to allow application right of the computer, and PC will check whether USB electronic disc has been inserted and whether the input code number is similar to that of the computer code number with the USB electronic disk, if not, the computer will prohibit the user's application by: cut off all the communication port function.

19. The method of implementing a guide device based on flash memory system as set forth in claim 18, the user has already loaded the driving program, the system will automatic open a code number window for the user to enter the code number and to compare with that in the USB electronic disc, and if the code number is not similar, and the user continues to use the computer, the computer will shut off by cutting off all the communication ports.
